(19) United States
(12) Patent Application Publication
(10) Pub. No.: US 2004/0010766 A1
(43) Pub. Date: Jan. 15, 2004

(54) Method and system for automated design of printed circuit boards

(76) Inventor: John M. Swope, Sacramento, CA (US)

Correspondence Address: HEWLETT-PACKARD COMPANY, Inellectual Property Administration, P.O. Box 272400, Fort Collins, CO, 80527-2400, US

(21) Appl. No.: 10/193,623

(22) Filed: Jul. 10, 2002

(51) Int. Cl. G06F 17/50

(52) U.S. Cl. 716/15

(57) ABSTRACT

A method and system for automated design of PC (printed circuit) boards is disclosed. The method includes receiving design constraints related to the design of a PC board, converting the design constraints into PC board design details and implementing a PC board design based on the PC board design details. The PC board design is automatically produced using the design constraints.

### FIELD OF THE INVENTION

Embodiments of the present invention relate generally to the design of printed circuit boards. In particular, embodiments of the present invention relate to a method and system that provide for the automated design of printed circuit boards.

### BACKGROUND OF THE INVENTION

A PC (printed circuit) board is a thin plate on which chips and other electronic components are placed. Computers generally consist of one or more PC boards which are often called cards or adapters. Schematics are used by PC board designers in the PC board design process to describe the function of the electrical circuits to be placed on the board. PC board designers must consider numerous design constraints correlated to the schematics in order to produce a workable PC board design.

In order to convert schematics into a finished PC board layout, one must manually go through a painstaking process involving steps such as: (1) determining routing rules given impedance requirements and signal integrity issues (such as signal speed, maximum allowable cross-talk, etc.), (2) determining a board stack up arrangement based on the numerous mechanical and electrical constraints that are presented, (3) determining an acceptable component placement scheme given known interconnection and mechanical constraints, (4) determining a trace routing scheme (often thousands of traces) to connect components that have already been placed (in complex designs this often must be done manually because the computer doesn't have a means of understanding the numerous constraints that are involved), (5) running DRCs (design rule checks) to detect any mistakes present in the PC board design, and (6) iterating through the above noted steps until a workable PC board layout is achieved. These steps represent only a partial listing of the steps involved in the painstaking process required to translate schematics into actual hardware, but highlight the complex and time consuming task involved in PC board design.

In addition, the process of utilizing schematics to create all of the artwork and documents necessary to fabricate a printed circuit board can be a time consuming and thus expensive undertaking, particularly where complex PC board designs are concerned. Producing a complex PC board design using conventional techniques may take up to three months or longer. The processes involved require an immense expenditure of time by skilled human labor. Accordingly, there is a continuing need to make such processes more efficient.

### SUMMARY OF THE INVENTION

A method and system for automated design of PC (printed circuit) boards are disclosed. In one embodiment, the method includes receiving design constraints related to the design of a PC board, converting the design constraints into PC board design details, and implementing a PC board design based on the PC board design details. The PC board design is automatically produced using the design constraints.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 shows a functional block diagram of one embodiment of the present invention.

FIG. 2 is a diagram that illustrates two levels of design abstraction of interest in an automated PC (printed circuit) board design process according to one embodiment of the present invention.

FIG. 3A is a chart containing a partial listing of high level mechanical constraints according to one embodiment of the present invention.

FIG. 3B is a chart containing a partial listing of high level electrical constraints according to one embodiment of the present invention.

FIG. 3C is a chart containing a partial listing of high level cost constraints according to one embodiment of the present invention.

FIG. 3D shows top and side views of a PC (printed circuit) board design that illustrate examples of low level detail according to one embodiment of the present invention.

FIG. 4 is a flowchart illustrating exemplary user design constraint inputs in accordance with one embodiment of the present invention.

FIG. 5 is a flowchart illustrating a response to user design constraint inputs according to one embodiment of the present invention.

FIG. 6 is a flowchart illustrating the automated design of printed circuit boards according to,one embodiment of the present invention.

FIG. 7 is a flowchart illustrating the automated design of printed circuit boards according to another embodiment of the present invention.

FIG. 8 is a flowchart of process steps that may be performed in accordance with one embodiment of the present invention.

FIG. 9 shows a general board stack-up scheme according to one embodiment of the present invention.

### DETAILED DESCRIPTION OF THE INVENTION

Reference will now be made in detail to the embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

According to one embodiment of the present invention, a computer (or some other processing software/hardware) is configured to perform automatically most of the PC (printed circuit) board design work completed in a PC board design production process. According to one embodiment, high level design constraints and corresponding engineering details of a subject electronic system are converted into low level design details which are implemented automatically into a final PC board design.

One embodiment of the present invention provides a PC board design system which accommodates the inputting of information that may include a PC board designer's schematics as well as numerous design constraints correlated to the schematics. The system then produces an output which is in whole or in part an electronic representation of a finished printed circuit board layout and design. The representation may include PC board component placement, board stack-up and/or trace routing schemes.

According to exemplary embodiments of the present invention, various implementations of the system are possible. The possible implementations may involve entirely new PC board design software systems or modifications of conventional PC board design software systems. In addition, embodiments of the present invention may be implemented by utilizing a software wrapper around a current system, or by utilizing any combination of software and/or dedicated hardware components. According to one embodiment, many technologies may be employed including traditional algorithms, artificial intelligence, genetic algorithms, and neural networks.

Advantages provided by various embodiments of the present invention include the elimination of numerous time consuming manual steps previously essential in the PC board design process. In addition, embodiments of the present invention allow speedier product time to market because of the greatly reduced PC board design production period. Other advantages include a realization of cost savings due to the reduced human involvement in the process, the ability to optimize PC board designs (by enabling the development of boards that are cheaper, faster, more robust, etc.), and the capacity to accommodate major design changes made by system users late in the design process. In addition, a PC board of a much higher quality may be produced in a matter of days, instead of the several months required by conventional methods. It should be appreciated that system users may also realize competitive advantages by capitalizing on the aforementioned features not found in conventional systems. Moreover, embodiments of the present invention will greatly assist in the design of products which are leveraged off of previous products. For example, one common set of schematics/constraints can be made into multiple different form factor products.

### Exemplary System in Accordance with Embodiments of the Invention

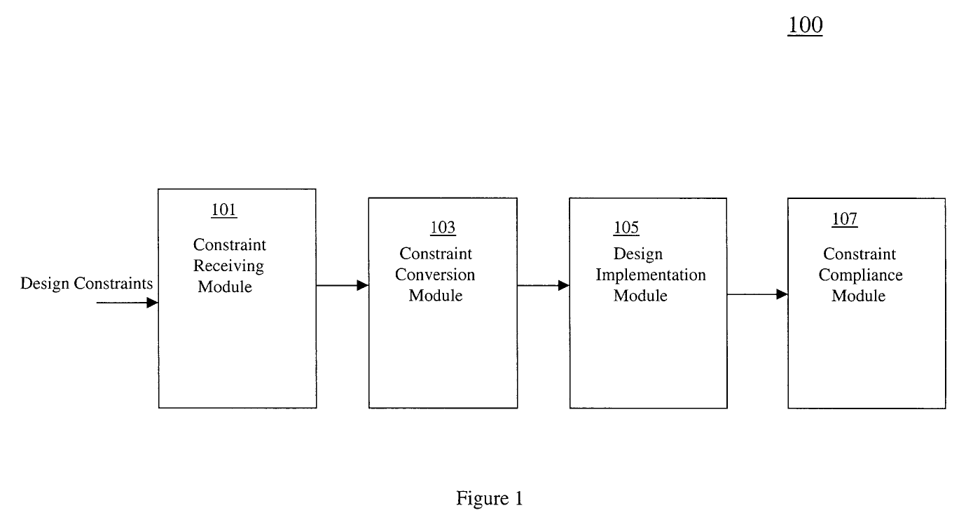

FIG. 1 shows a functional block diagram 100 of one embodiment of the system of the present invention. Exemplary embodiments allow a system user to “front load” design constraints that the system is configured to understand. These design constraints are translated into low level design detail that facilitate the automated implementation of a PC board design. Referring to FIG. 1, there is shown constraint receiving module 101, design constraint conversion module 103, design implementation module 105, and constraint compliance module 107.

Constraint receiving module 101 accommodates the receiving of PC board design constraints. According to one embodiment these constraints may be operator provided. In alternate embodiments, the constraints may be provided in any manner allowing a provision of such constraints. It should be appreciated that data receiving interfaces may be employed to accommodate the receiving of the design constraints. According to one embodiment, the data receiving interface may include a graphical user interface that accommodates the receiving of design constraints. In alternate embodiments, other types of data receiving means may be employed. The design constraints received may include but are not limited to schematic, mechanical, and cost design constraints. According to one embodiment, this information is used for more than documentary purposes. According to one embodiment, the system is programmed to understand these constraints and may translate them into low level design detail. This information may be provided by a system operator and may be used to guide the design of the printed circuit board. The schematics supplied by a system user may include but are not limited to electrical engineering diagrams that describe the basic component interconnection scheme employed in the design. The mechanical constraints may include manufacturing rules related to design attributes that include but are not limited to board size, board thickness, trace thickness etc. Other constraints may include but are not limited to the type of board technology used and the number of layers to be employed.

Design constraint conversion module 103 converts high level design specifications received from data receiving module 101 into low level design details. High level design constraints include operator provided design specifications that may be “front loaded” by a system operator. Low level design details are derived from the operator provided constraints. User provided constraints may include but are not limited to constraints such as schematic, mechanical, cost, etc., while low level detail may include PC board design specifics (in actual inches, microns, etc.) such as attributes of trace routing (e.g., length, width, height and configuration of traces, etc.), component placement, and PC board stack-up.

Design implementation module 105 implements a design that complies with the high level design constraints that are received by constraint receiving module 101 and that are converted into low level design detail by conversion module 103. It should be appreciated that, according to one embodiment of the present invention, a manual integration of operator provided design choices into the automatically generated PC board design may be executed at any stage of the PC board design process. The capacity to accommodate such design choice integration may facilitate PC board design optimization. In addition, other optimization techniques may be employed such as iterative design processes.

Constraint compliance module 107 performs rule checks that verify PC board design compliance with specified design constraints. Component placement, board stacking and trace routing that violate design rules may also be detected through these processes. Other aspects of design compliance that may be verified include, but are not limited to, design compliance with manufacturer's specifications such as manufacturer specified trace distances and trace widths. In addition, basic electric circuit analyses and troubleshooting may be performed such as by short checking, etc. According to one embodiment, the system may automatically resolve a problem detected through these processes or may alert a system user so that the user may provide a resolution.

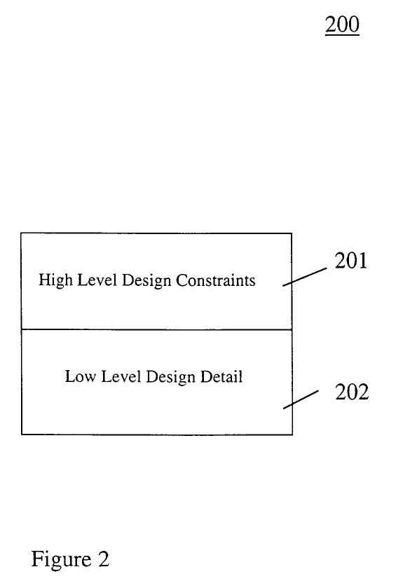

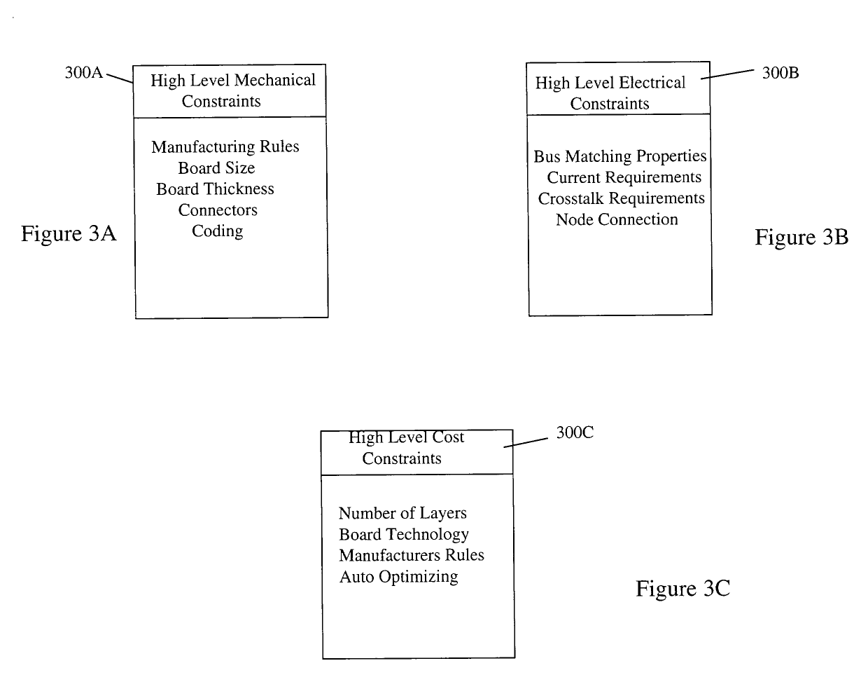

FIG. 2 is a diagram 200 that illustrates two levels of design abstraction of interest in the autonomous PC board design process according to one embodiment of the present invention. Referring to FIG. 2, there are shown high level design constraints 201 and low level design detail 202. At the highest level of design abstraction are high level design constraints 201. As previously mentioned, high level design constraints 201 may include user provided design specifications that may be “front loaded” by a system user. At the lowest level of design abstraction are low level design details 202. Low level design details 202 are derived from the provided high level design constraints 201 and facilitate the implementation of the PC board design. As previously mentioned, operator provided constraints include but are not limited to constraints such as schematic, mechanical, cost, etc. Low level design detail may include PC board design specifics (in actual inches, microns, etc.) such as trace routing (e.g., length, width, height and configuration of traces, etc.), component placement, and board stacking details. FIGS. 3A-3C are charts that include partial lists of the high level constraints from which low level design detail are derived.

FIG. 3A is a chart 300A containing a partial listing of high level mechanical constraints according to one embodiment of the present invention. High level mechanical constraints include but are not limited to manufacturing rules, board size, board thickness, coding, etc. According to exemplary embodiments, these constraints may be “front loaded” as the system is able to understand the constraints and translate or convert them into low level design detail.

FIG. 3B is a chart 300B containing a partial listing of high level electrical constraints according to one embodiment of the present invention. High level electrical constraints include but are not limited to bus matching properties, current requirements, cross-talk requirements, etc. According to exemplary embodiments, these constraints may be “front loaded” as the system is able to understand the constraints and translate or convert them into low level design detail.

FIG. 3C is a chart 300C containing a partial listing of high level cost constraints according to one embodiment of the present invention. High level cost constraints may include but are not limited to number of layers provided, board technology, etc. According to exemplary embodiments, these constraints may be “front loaded” as the system is able to understand the constraints and translate or convert them into low level design detail.

FIG. 3D shows top 300D and side 310D views of a PC board design that illustrate examples of low level detail according to one embodiment of the present invention. Referring to FIG. 3D there is shown trace routing detail 301, component placement detail 303, and board stacking detail 305. The low level design details are derived from the provided high level design constraints and facilitate the implementation of the PC board design. As previously mentioned, operator provided constraints include but are not limited to constraints such as schematic, mechanical, cost, etc. The low level design detail that is derived from the constraints describe PC board design specifics such as trace routing detail 301 (e.g., length, width, height and configuration of traces, etc.), component placement detail 303, and board stacking detail 305 by providing their specific configuration in actual inches, microns, etc.

### Exemplary Operations in Accordance with Embodiments of the Invention

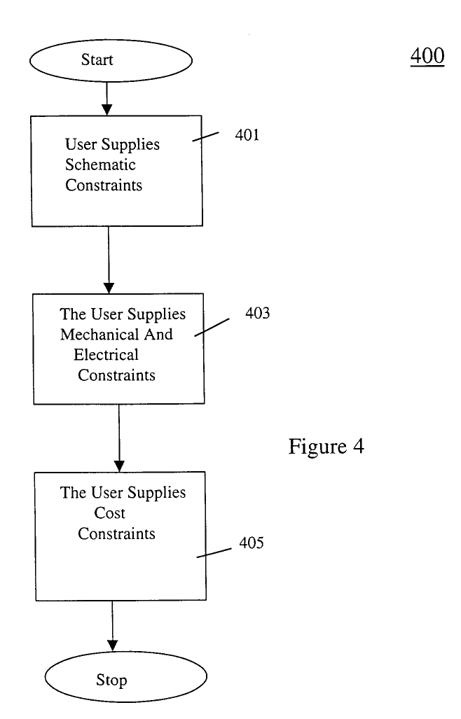

FIGS. 4-8, show flowcharts 400-800, illustrating computer controlled methods of automated circuit board design according to various embodiments of the present invention. The flowcharts 400-800 include processes which, in one embodiment, are carried out by processors and electrical components under the control of computer readable and computer executable instructions. The computer readable and computer executable instructions reside, for example, in data storage features such as computer usable volatile memory and/or computer usable non-volatile memory. However, the computer readable and computer executable instructions may reside in any type of computer readable medium. Although specific steps are disclosed in the flowcharts, such steps are exemplary. That is, the present invention is well suited to performing various other steps or variations of the steps recited in the flowcharts. Within the present embodiment, it should be appreciated that the steps of the flowcharts may be performed by software, by hardware or by a combination of both.

FIG. 4 is a flowchart 400 illustrating exemplary user design constraint inputs in accordance with one embodiment of the present invention. At step 401, the user supplies schematic constraints. The schematic constraints supplied by a system user may include but are not limited to electrical engineering diagrams that describe the interconnection of circuit components of a circuit to be mounted on the printed circuit board. Also supplied by the system user may be high level constraints such as cross-talk requirements, node connection termination requirements, and bus matching properties. According to one embodiment of the present invention the schematics and other high level constraints may be supplied by the user via a single page of a user interface. According to one embodiment the user interface may be a graphical user interface. In alternate embodiments, any other interface that may accommodate the entry of the aforementioned schematic and constraint information may be employed.

At step 403, the user supplies electrical and mechanical constraints. According to one embodiment the user may supply a mechanical model (e.g., a 3D drawing, etc.) which describes where components may and may not be placed. These constraints establish general rules that may not be violated in the automated generation of the printed circuit board design. The mechanical constraints may also include manufacturing rules that may relate to but are not limited to board size, board thickness, trace thickness, etc. Electrical constraints may include but are not limited to bus matching properties, current requirements, cross-talk requirements, etc.

At step 405, the user may supply other constraints such as those having to do with cost. These constraints may include but are not limited to the board technology type employed and the number of layers that may be utilized.

According to one embodiment of the present invention, a user may interact manually in concert with system automated design processes at any stage to ensure that a desired PC board design may be achieved. For example, a system user may be allowed to dictate the placement of a component or series of components manually, and have the manually dictated component placement be incorporated into a system generated component placement scheme. According to one embodiment, this manual input may be executed as the placement scheme is being generated. Alternatively, the user could interact manually after a step in the process has been completed (e.g., after the system performs an autonomous placement of components the user may direct the placement of a component or series of components). In addition, a system user may interact after the entire printed circuit board design has been completed. Consequently, the system allows user interaction at any point in the process including an intermediate or final stage.

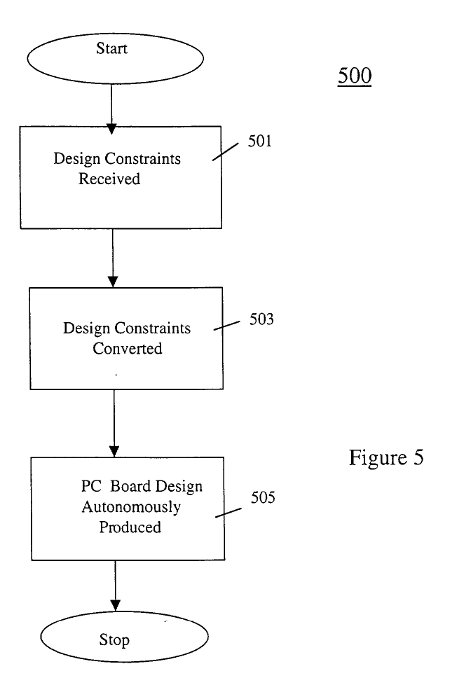

FIG. 5 is a flowchart of steps performed in the automated design of printed circuit boards according to one embodiment of the present invention. FIG. 5 illustrates system responses to inputs such as from a system user as was described with reference to FIG. 4.

At step 501, design constraints are received (e.g., accessed). Design constraints may include but are not limited to schematic, mechanical electrical, and cost constraints. This information may be provided by a system user and is used to guide the design of the printed circuit board. The schematics supplied by a system user may include but are not limited to electrical engineering diagrams that describe the interconnection of the circuit components to be mounted on the printed circuit board. The mechanical constraints may include manufacturing rules that may be related to but are not limited to board size, board thickness, trace thickness, etc. Other design constraints may include but are not limited to the board technology type employed and the number of layers to be employed.

At step 503, design constraints are converted (e.g., translated) into low level PC board design detail. This detail may be used to produce a PC board design having attributes and properties that comply with the provided constraints. The details may be related to but are not limited to board stack up (e.g., configuration, thickness of layers, etc.) component placement (e.g., configuration, distances between), and tracing schemes (e.g., configuration, distances between, height, width, etc.).

At step 505, a PC board design is automatically produced in accordance with the specified constraints. According to one embodiment of the present invention, a system user may optimize the PC board design by manually directing the integration of design enhancements intuitively suggested by the automatically produced design. By contrast, an auto optimization process may be executed where successive iterations between process steps may be performed. According to one embodiment, manual input may be facilitated at any stage of the automated design process.

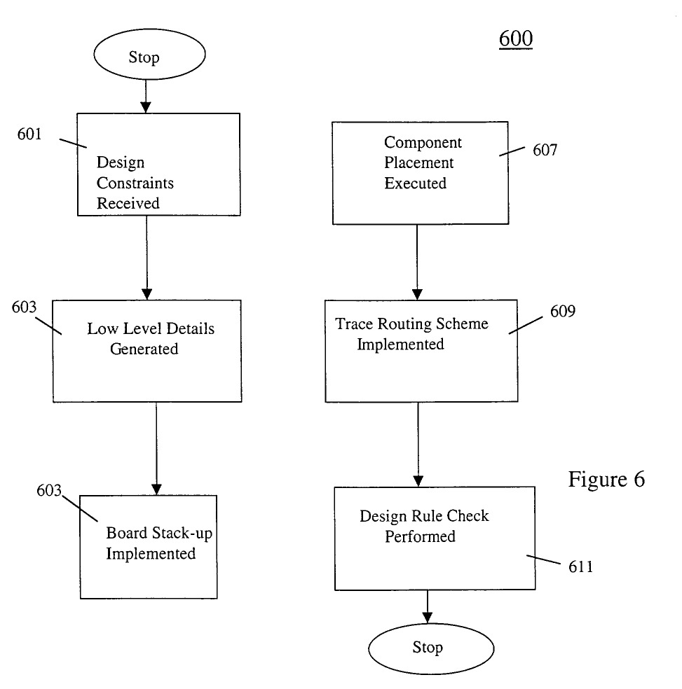

FIG. 6 is a flowchart of steps performed in the automated design of printed circuit boards according to one embodiment of the present invention.

At step 601, design constraints are received. According to one embodiment, the design constraints received may be in the form of high level design constraints supplied by a system user. These constraints may include but are not limited to schematic, electrical, mechanical, cost etc. These constraints guide the automated design of printed circuit boards

At step 603, high level constraints received from the system user are converted into the low level design details needed to actually implement the design. This low level detail (design details) may be generated automatically from the constraints received from a system user and may provide details of the printed circuit board design and layout (e.g., given high level constraints the system may automatically determine low level details of the PC board design related to the location of components, board stack-up dimensions, and the height and width of traces).

At step 605, a PC board stack-up is implemented. The implementation is based on the low level design detail generated in step 603. It should be appreciated that board stack up may be performed manually as manual interaction is possible at any point according to one embodiment of the present invention. According to one embodiment of the present invention a stack-up scheme may employ several levels of interleaved copper and fiberglass layers. Because such complex stack-ups may involve significant cost overhead, an objective of one embodiment of the present invention is to provide an optimal stack-up arrangement given a set of provided design constraints. According to one embodiment, an optimal stack-up arrangement may produce the thinnest printed circuit board possible.

At step 607, a placement of circuit components on the PC board real estate is executed. The placement of the components is based on the low level design details generated in step 603. According to one embodiment, component placements dictated as “must” (e.g., the most constrained components) are executed prior to the placement of other components whose placement may be influenced by other factors that include but are not limited to convenience, route length, etc.

At step 609, a trace routing scheme is implemented. The traces thus provided connect components placed in step 607. Low level design details generated in step 603 facilitate the implementation of the trace routing scheme. According to one embodiment, all constraints may be taken into account. A significant factor in the trace routing implementation process may be the impedances of the various traces on the PC board. This is because the thickness of each of the layers may be determined in part by the impedances that run on that particular layer. Consequently, these impedances may dictate such physical attributes of the routing anatomy as the height and width of the signal traces that form the routing between given components.

At step 611, a design rule check is performed. The system verifies that the design rules have been followed. Component placement, trace routing, etc., that violate the design rules may be detected at this step. Other aspects of the PC board design that may be examined in this step include but are not limited to manufacturers specifications related to trace distances and trace width. In addition, basic electric circuit analyses may be performed such as short checking, trouble shooting, etc.

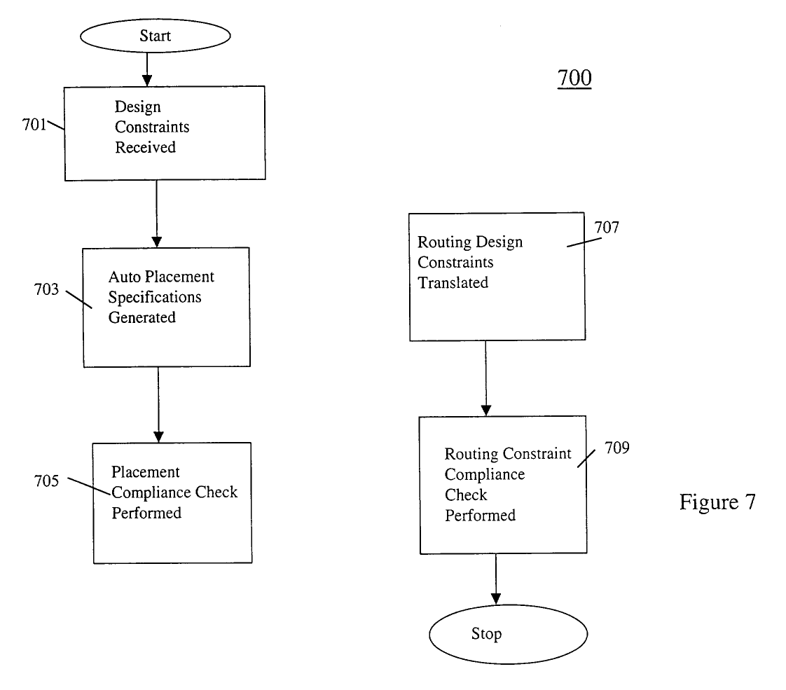

It should be appreciated that in order to find an optimal printed circuit board design, ample iteration may be necessary. According to one embodiment, the process may iterate freely back and forth between steps, executing necessary self checks, in order that an optimal PC board design may be achieved. The flowchart of FIG. 7 describes one such process performed in accordance with one embodiment of the present invention. The method of FIG. 7 illustrates a process that provides for compliance checking after design details have been generated at the component placement, board stack-up and trace routing steps.

FIG. 7 is a flowchart 700 of steps performed in the automated design of printed circuit boards according to one embodiment of the present invention. At step 701, design constraints are received. The design constraints received may be in the form of high level design specifications provided by a system user. These constraints may include but are not limited to schematic, electrical mechanical and cost constraints, etc. These constraints guide the automated design of printed circuit boards.

At step 703, the design constraints received in step 701 are converted into component auto placement specifications, which are used to guide the automatic placement of circuit components on the PC board real estate. The placement of the components is based on the high level design specifications received in step 701. According to one embodiment, component placements dictated as “must” (e.g., the most constrained components) are performed prior to the placement of other components whose placement may be influenced by other factors that include but are not limited to convenience, route length, etc.

At step 705, a placement constraint compliance and analysis check is completed. The system verifies that the design rules have been followed. Component placements that violate the design rules may be detected at this step. Other aspects of component placement that may be examined in this step include but are not limited to design compliance related to promulgated manufacturers specifications that have to do with the placement of components.

At step 707, routing design constraints are translated into low level routing details, which facilitate the implementation of the tracing scheme. Traces may be routed between the components placed in step 705. Routing is facilitated by the low level design detail derived from the provided constraints. All constraints provided in step 701 may be taken into account.

At step 709, a routing constraint compliance and analysis check is completed. The system verifies that the design rules have been followed. Aspects of the trace routing scheme that violate design rules may be detected at this step. According to one embodiment, design rules may consist of rules of thumb. Other aspects of the PC board design that may be examined in this step include but are not limited to design compliance with promulgated manufacturers specifications such as trace distances and trace width. In addition, basic electric circuit analyses and troubleshooting may be performed such as by short checking, etc. According to one embodiment, the system may automatically resolve any problem or alert the user so that the user may provide a resolution.

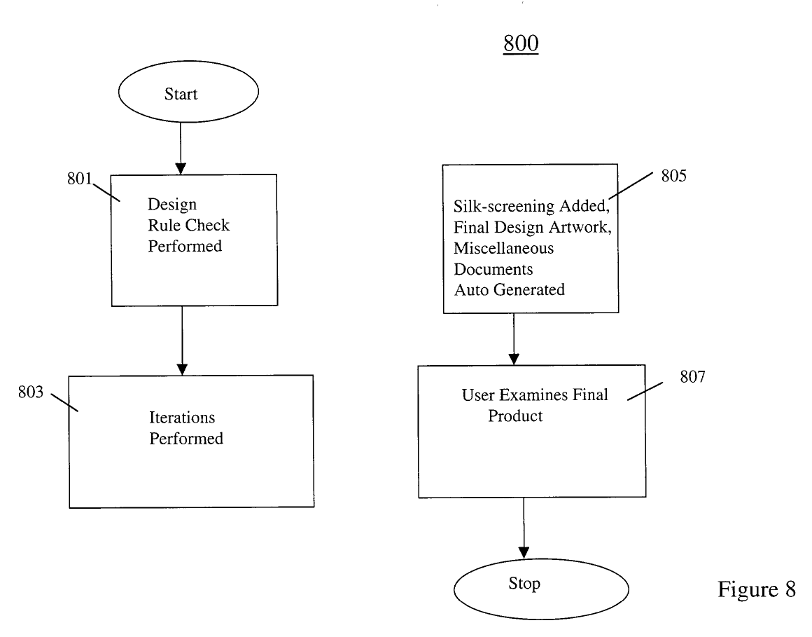

FIG. 8 is a flowchart 800 of process steps that may be performed in the autonomous printed circuit board design process in accordance with one embodiment of the present invention. Steps 801-807 detail optional final steps that may be employed in the autonomous design process according to exemplary embodiments.

At step 801, a design rule check including cross-talk and power analysis is performed. As previously mentioned, the system verifies that the design rules have been followed. Component placement, route traces, etc., that violate the design rules may be detected at this step. Other aspects of the PC board design that may be examined in this step include but are not limited to manufacturer promulgated specifications such as trace distances and trace widths. In addition, according to one embodiment, basic electric circuit analyses may be performed such as power analysis, cross-talk analysis, short checking etc.

At step 803, iterations are performed using different PC board technologies. In one embodiment the technologies are lower cost technologies. In another embodiment, iterations may be performed utilizing the PC board technology used originally. In this step, system processes that affect the modification of the PC board design to best meet design constraint requirements are repeated such that an optimal design may be found.

At step 805, silk-screening may be added and the final design artwork and miscellaneous documents auto-generated. An example of such artwork may include but is not limited to stack up drawings that determine which materials are to be used and how the PC board will actually be fabricated. According to one embodiment, these documents may comprise artwork pages that correspond to the various PC board layers. According to one embodiment, a title block for each artwork page may include but is not limited to a company name, etc. As with other steps, according to one embodiment, silk-screening operations may be performed manually.

At step 807, the system user examines the final product and sends to CM (contract manufacturer). According to one embodiment neural networks may be employed to help in the generation of the board stack up, the placement of the components and board lay out.

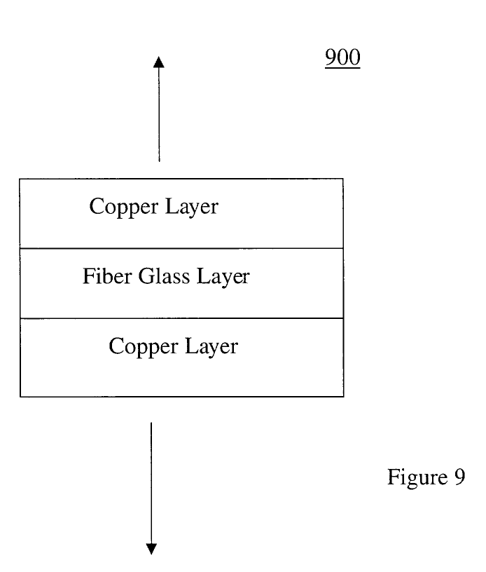

FIG. 9 shows a general stack-up scheme 900 according to one embodiment of the present invention. Referring to FIG. 9, there is shown copper layers 901, fiberglass layer 903 and copper layers 905. According to one embodiment of the present invention a stack-up scheme may employ several levels of interleaved copper and fiberglass layers. Because, such complex stack-ups may involve significant cost overhead, an objective of one embodiment of the present invention is to provide an optimal stack-up arrangement given the provided design constraints. According to one embodiment, an optimal stack-up arrangement should produce the thinnest printed circuit board possible. Such a printed circuit board has the least number of layers possible given the provided constraints. As previously mentioned, a significant factor in this process may be the impedances of the various layers because the thickness of each of the layers may be determined in part by the impedances that run on that particular layer. Consequently, these impedances may dictate such physical details as the height of particular signal traces. It should be appreciated that the stack-up scheme employed may be either user or computer generated.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method for automated printed circuit board design, the method comprising:
receiving design constraints related to a design of a PC (printed circuit) board;
converting said design constraints into PC board design details; and
producing said PC board design based on said PC board design details,
wherein a PC board design is automatically produced using said design constraints.

2. The method of claim 1, wherein said design constraints comprise schematic, electrical, and mechanical constraints.

3. The method of claim 1, wherein said design details comprise component placement design details, board stack-up design details, and trace routing design details.

4. The method of claim 3, further comprising:
verifying compliance with said design constraints by performing DRC (design rule check), cross-talk and power analysis.

5. The method of claim 4, further comprising:
independently performing iterations using first and second PC board technologies.

6. The method of claim 5, further comprising:
automatically performing a final silk-screening; and
auto generating artwork and documents.

7. The method of claim 1, further comprising:
incorporating a design choice that is received into a design produced through automation at any stage of the automated design process.

8. A computer useable medium having computer useable code embodied therein causing a computer to perform operations comprising:
accommodating receiving of PC (printed circuit) board design constraints related to the design of a PC board;
translating said design constraints into PC board design details; and
creating a PC board design based on said PC board design details,
wherein a PC board design is automatically produced using PC board design details derived from said PC board design constraints.

9. The computer useable medium of claim 8, wherein said design constraints comprise schematic electrical, and mechanical constraints.

10. The computer useable medium of claim 8, wherein said design details comprise component placement design details, board stack up design details, and trace routing design details.

11. The computer useable medium of claim 10, wherein constraint compliance is verified by performing DRC (design rule check), cross-talk, and power analysis.

12. The computer useable medium of claim 11, wherein iterations using first and second PC board technologies are independently performed.

13. The computer useable medium of claim 12, wherein a final silk-screening is automatically performed and artwork and documents are auto generated.

14. The computer useable medium of claim 8, wherein design choices are received that are incorporated into an automatically generated design at any stage of an automated design process.

15. A computer system comprising:
a bus;
a computer readable memory unit connected to said bus;
a processor coupled to said bus said processor for executing a method for implementing an application comprising:
assessing design constraints related to the design of a PC (printed circuit) board;
transforming said design constraints into PC board design details; and
generating a PC board design based on said PC board design details,
wherein a final PC board design is automatically produced using said PC board design constraints.

16. The computer system of claim 15, schematic, electrical, and mechanical constraints are included in said design constraints.

17. The computer system of claim 15, wherein component placement design details, board stack up design details, and trace routing design details are included in said design details.

18. The computer system of claim 17, wherein DRC (design rule check), cross-talk, and power analysis is performed to verify constraint compliance.

19. The computer system of claim 18, wherein iterations are Independently performed using first and second PCB technologies.

20. The computer system of claim 19, wherein the system automatically performs a final silk-screening and auto generates documents and artwork.

21. The computer system of claim 15, wherein the system accommodates incorporating design choices into an automatically generated design at any stage of an automated design operation.
